(19) United States
(12) Patent Application Publication
(10) Pub. No.: US 2026/0017968 A1
(43) Pub. Date: Jan. 15, 2026

(54) INFORMATION PROCESSING DEVICE, INFORMATION PROCESSING METHOD, AND INFORMATION PROCESSING PROGRAM

(71) Applicant: NIPPON TELEGRAPH AND TELEPHONE CORPORATION, Tokyo (JP)

(72) Inventors: Shota ORIHASHI, Musashino-shi, Tokyo (JP); Ryo MASUMURA, Musashino-shi, Tokyo (JP)

(73) Assignee: NIPPON TELEGRAPH AND TELEPHONE CORPORATION, Tokyo (JP)

(21) Appl. No.: 18/995,183

(22) PCT Filed: Jul. 19, 2022
(86) PCT No.: PCT/JP2022/028129

§ 371 Date: Jan. 16, 2025

(51) Int. Cl. G06V 30/194

(52) U.S. Cl. CPC G06V 30/194

(57) ABSTRACT

An information processing apparatus includes processing circuitry configured to extract an image feature from a character image, and estimate a character string from a writing direction and the image feature.

### TECHNICAL FIELD

The present invention relates to an information processing apparatus, an information processing method, and an information processing program.

### BACKGROUND ART

A scene image obtained by capturing a scene includes many pieces of character information necessary for understanding the image, such as that of traffic signs and advertisement signboards. Scene character recognition is a task of recognizing captured characters using an image (hereinafter, a character image) obtained by cutting out a character region from such a scene image as an input and converting the characters into a character string that can be processed by a machine. In recent years, with the progress of deep learning technology, a method of implementing scene character recognition with a one-stop type model has been proposed.

### CITATION LIST

### Non Patent Literature

Non Patent Literature 1: F. Sheng, Z. Chen, and B. Xu, “NRTR: A no-recurrence sequence-to-sequence model for scene text recognition”, Proceedings of the IEEE International Conference on Document Analysis and Recognition (ICDAR), pp. 781-786, 2019.

Non Patent Literature 2: A. Vaswani, N. Shazeer, N. Parmar, J. Uszkoreit, L. Jones, A. N. Gomez, L. Kaiser, and I. Polosukhin, “Attention is all you need”, Advances in Neural Information Processing Systems (NIPS), pp. 5998-6008, 2017.

Non Patent Literature 3: C. Choi, Y. Yoon, J. Lee, and J. Kim, “Simultaneous recognition of horizontal and vertical text in natural images”, in Proceedings of the International Workshop on Robust Reading, ACCV, 2019, pp. 202-212.

For example, Non Patent Literature 1 provides a scene character recognition technology using a model including an encoder and a decoder as schematically illustrated in FIG. 1. At this time, the encoder includes, for example, a part that extracts a feature of a character image by a convolutional neural network and a part that converts the feature into a feature in consideration of a series by a transformer encoder provided in Non Patent Literature 2. The decoder includes, for example, an embedded layer, a transformer decoder provided in Non Patent Literature 2, and an autoregressive model using an output layer, and outputs a generation probability of a character string from a feature of the character image (hereinafter, an image feature) extracted by the encoder. Using such a model, a generation probability P of a character string C={c_1, . . . , c_T} written in a character image I is modeled as follows. Here, Θ is a learnable model parameter.

$$\begin{matrix}[ Math . 1 ] & \\ P ( C \vert I ; Θ ) = {\prod }_{t = 1}^{T} P ( {c}_{t} \vert I , {c}_{1} , … , {c}_{t - 1} ; Θ ) & ( 1 )\end{matrix}$$

In some Asian languages such as Japanese, there are two types of writing directions of horizontal writing and vertical writing. At this time, for example, characters can be recognized by using different character recognition models for horizontal writing and vertical writing; however, in order to perform learning of the two models, it is necessary to sufficiently collect both teacher data, which is not efficient. Thus, a configuration has been proposed of a model that enables character recognition in horizontal writing and vertical writing by a single model and shares model parameters that can be shared.

For example, in Non Patent Literature 3, as schematically illustrated in FIG. 23, by sharing parameters of a model between horizontal writing and vertical writing, it is possible to perform character recognition in horizontal writing and vertical writing by a single model. In a baseline illustrated in FIG. 23(a), on the premise that a character image in vertical writing is rotated counterclockwise by 90 degrees and input, all parameters of the model are shared by horizontal writing and vertical writing, and a model is implemented capable of recognizing both character strings in two writing directions. In a method called a direction encoding mask (DEM) illustrated in FIG. 23(b), an image representing the writing direction is combined in a channel direction and input with respect to the baseline, whereby modeling based on the writing direction is implemented. In a method called a selective attention network (SAN) illustrated in FIG. 23(c), a part of the model is split into horizontal writing and vertical writing with respect to the baseline, whereby accuracy is improved of the character recognition model according to the writing direction. For example, only a transformer encoder in FIG. 1 is split into horizontal writing and vertical writing, and other components are shared.

### SUMMARY OF INVENTION

### Technical Problem

However, the conventional technology has a problem that a model capable of recognizing both horizontal writing and vertical writing cannot be created unless a large amount of teacher data of both horizontal writing and vertical writing is collected. For example, when learning is performed of a model capable of recognizing both horizontal writing and vertical writing as implemented by Non Patent Literature 3, an image indicating the writing direction is combined and input in the DEM, and thus, for learning of a model capable of reading both horizontal writing and vertical writing, sufficient teacher data for both are required. Similarly, since the model is not partially shared in the SAN, it is necessary to sufficiently collect teacher data of both horizontal writing and vertical writing in this case as well. However, in general, it is difficult to collect a character image in vertical writing in an actual environment as compared with horizontal writing.

### Solution to Problem

In order to solve the above-described problems and achieve an object, an information processing apparatus according to the present invention includes a feature extraction unit and a character string estimation unit. The feature extraction unit extracts an image feature from a character image. The character string estimation unit estimates a character string from a writing direction and the image feature.

In addition, an information processing apparatus according to the present invention includes a feature extraction unit, a character string estimation unit, and a learning unit. The feature extraction unit extracts an image feature from a character image. The character string estimation unit estimates a character string from a writing direction and the image feature. The learning unit performs learning of a model of performing processing by the feature extraction unit and the character string estimation unit on a basis of a correct character string corresponding to the character image, and the estimated character string.

### Advantageous Effects of Invention

According to the present invention, it is possible to solve the problem that it is not possible to create a model capable of recognizing both horizontal writing and vertical writing unless a large amount of teacher data of both horizontal writing and vertical writing is collected.

### BRIEF DESCRIPTION OF DRAWINGS

FIG. 1 is a diagram illustrating a character recognition model of a conventional technology.

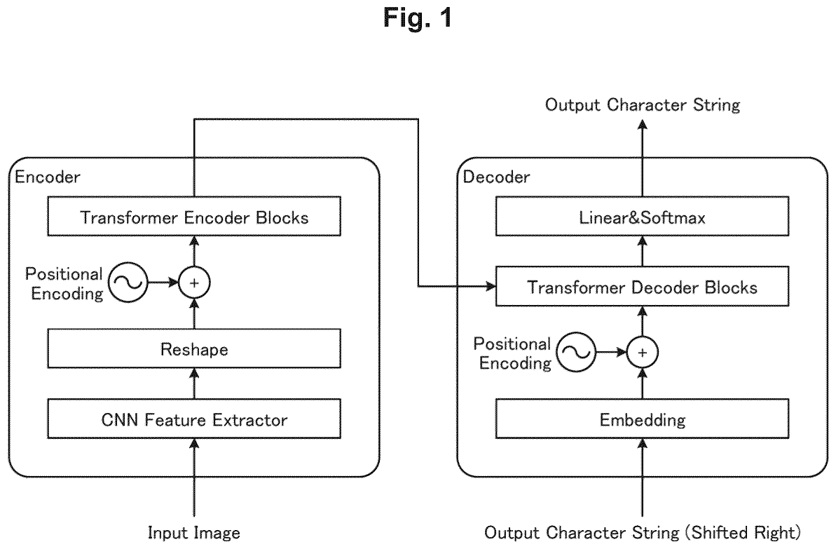

FIG. 2 is a block diagram illustrating an example of a configuration of an information processing apparatus.

FIG. 3 is a diagram illustrating an example of the configuration of the information processing apparatus at the time of estimation.

FIG. 4 is a diagram illustrating an example of processing by the information processing apparatus.

FIG. 5 is a diagram illustrating an example of the configuration of the information processing apparatus at the time of learning.

FIG. 6 is a flowchart illustrating an example of a flow of the processing by the information processing apparatus.

FIG. 7 is a diagram illustrating an example of the configuration of the information processing apparatus at the time of estimation.

FIG. 8 is a diagram illustrating an example of the processing by the information processing apparatus.

FIG. 9 is a diagram illustrating an example of the configuration of the information processing apparatus at the time of estimation.

FIG. 10 is a diagram illustrating an example of the processing by the information processing apparatus.

FIG. 11 is a diagram illustrating an example of the configuration of the information processing apparatus at the time of learning.

FIG. 12 is a flowchart illustrating an example of the flow of the processing by the information processing apparatus.

FIG. 13 is a diagram illustrating an example of the configuration of the information processing apparatus at the time of estimation.

FIG. 14 is a diagram illustrating an example of the configuration of the information processing apparatus.

FIG. 15 is a diagram illustrating an example of the configuration of the information processing apparatus at the time of estimation.

FIG. 16 is a diagram illustrating an example of the processing by the information processing apparatus.

FIG. 17 is a diagram illustrating an example of the configuration of the information processing apparatus at the time of estimation.

FIG. 18 is a diagram illustrating an example of the processing by the information processing apparatus.

FIG. 19 is a diagram illustrating an example of the configuration of the information processing apparatus at the time of learning.

FIG. 20 is a flowchart illustrating an example of the flow of the processing by the information processing apparatus.

FIG. 21 is a diagram illustrating an example of the configuration of the information processing apparatus at the time of estimation.

FIG. 22 is a diagram illustrating an example of the processing by the information processing apparatus.

FIG. 23 is a diagram illustrating a character recognition model according to a conventional technology.

FIG. 24 is a table illustrating character string estimation results by the information processing apparatus.

FIG. 25 is a diagram illustrating a character string estimation result by the information processing apparatus.

FIG. 26 is a diagram illustrating an example of a computer that executes an information processing program.

### DESCRIPTION OF EMBODIMENTS

Hereinafter, embodiments of an information processing apparatus, an information processing method, and an information processing program according to the present application will be described in detail with reference to the drawings. Note that the present invention is not limited by the embodiments. In addition, in the description of the drawings, the same portions are denoted by the same reference sign, and redundant description is omitted.

### Summary of Present Invention

An information processing apparatus 100 according to the present embodiments implements highly accurate character string estimation by using a result of performing estimation of a writing direction and estimation of the number of characters for character string estimation by an encoder and decoder model.

For example, in character recognition, by sharing all model parameters between horizontal writing and vertical writing, the information processing apparatus 100 shares outlines peculiar to characters useful for character recognition and vocabulary between the horizontal writing and the vertical writing, and then, in order to correctly decode the horizontal writing and the vertical writing, provides a token for distinguishing the horizontal writing and the vertical writing as an initial value of an autoregressive decoder, thereby implementing highly accurate character string estimation. At this time, the present invention can be applied to general technologies of outputting a character string from a character image through a model of an arbitrary encoder and decoder type having an autoregressive decoder. In addition, the present invention is also applicable to optical character recognition and the like.

In addition, for example, prior to the processing of predicting a character string, the information processing apparatus 100 predicts the number of characters of a character described in a character image, and outputs the character string on the basis of the prediction result. As a result, prior to the processing of predicting a character string, the number of characters is predicted in which a character image is required to be captured in a bird's eye view, that is, a character is recognized after a group of characters is captured, and thus, it is prevented that a left-hand portion and a right-hand portion are erroneously divided or combined and then a character is recognized, and accuracy of character string estimation is improved. At this time, the present invention can be applied to general technologies for outputting a character string from a character image through an arbitrary end to end sequence to sequence model. In addition, the present invention is also applicable to optical character recognition and the like.

### Configuration of Information Processing Apparatus

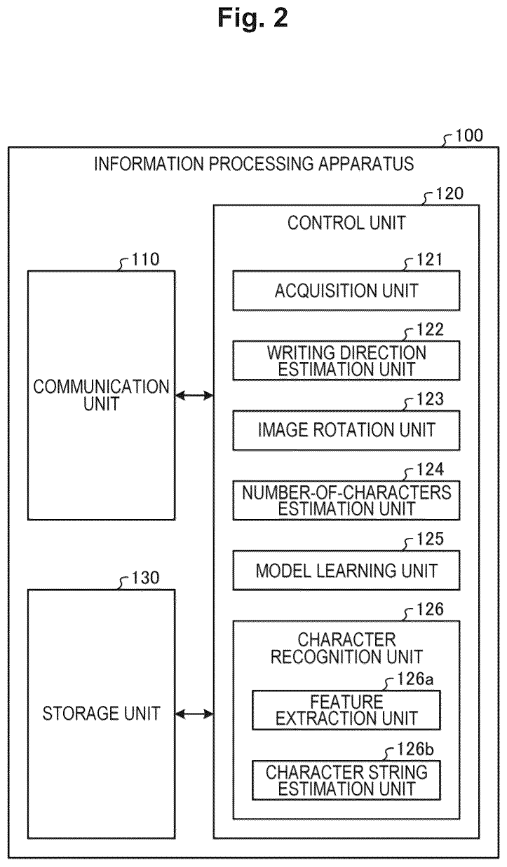

First, a configuration of the information processing apparatus will be described with reference to FIG. 2. As illustrated in FIG. 2, the information processing apparatus 100 includes a communication unit 110, a control unit 120, and a storage unit 130. Note that a plurality of devices may hold these units in a distributed manner. Hereinafter, processing by each of these units will be described.

The communication unit 110 is implemented by a network interface card (NIC) or the like and enables communication between an external device and the control unit 120 via an electrical communication line such as a local area network (LAN) or the Internet. For example, the communication unit 110 enables communication between an external device and the control unit 120.

The storage unit 130 is implemented by a semiconductor memory element such as a random access memory (RAM) or a flash memory, or a storage device such as a hard disk or an optical disc. Information stored in the storage unit 130 includes, for example, a character image, an image feature, data related to a machine learning algorithm, teacher data, a learned model, and the like. Note that the information stored in the storage unit 130 is not limited to the information described above.

The control unit 120 is implemented by using a central processing unit (CPU), a network processor (NP), a field programmable gate array (FPGA), or the like, and executes a processing program stored in a memory. As illustrated in FIG. 2, the control unit 120 includes an acquisition unit 121, a writing direction estimation unit 122, an image rotation unit 123, a number-of-characters estimation unit 124, a model learning unit (learning unit) 125, a character recognition unit 126, an encoder (feature extraction unit) 126a, and a decoder (character string estimation unit) 126b. Hereinafter, each unit included in the control unit 120 will be described.

Note that division of functional units in the configuration diagram is an example, and may be implemented by only some functional units, a plurality of functional units may be implemented as one functional unit, one functional unit may be divided into a plurality of functional units, or some functions may be moved to another functional unit. In addition, functions of a plurality of functional units having similar functions may be processed in parallel or in a time division manner by a single piece of hardware or software.

The acquisition unit 121 acquires a character image. The writing direction estimation unit 122 uses the character image acquired by the acquisition unit 121 as an input to a model (hereinafter, a writing direction estimation model) of estimating a writing direction, estimates the writing direction, and outputs an estimated writing direction.

For example, the writing direction estimation unit 122 may use a writing direction estimation model of determining, depending on an aspect ratio of the character image, horizontal writing if the character image is horizontally long and vertical writing if the character image is vertically long. In addition, for example, the writing direction estimation unit 122 may define a determination model of outputting the estimated writing direction using the character image or the image feature as an input by a machine learning model, perform learning in advance using teacher data, and then use the determination model as the writing direction estimation model.

Note that, as the writing direction handled by the information processing apparatus 100, in addition to vertical writing and horizontal writing, any direction may be used that covers inversion, rotation, and the like and represents how to read characters. For example, the information processing apparatus 100 may use all combinations of “vertical writing or horizontal writing, inverted or non-inverted, and rotated counterclockwise by 0 degrees or 90 degrees or 180 degrees or 270 degrees” as the writing direction.

The image rotation unit 123 uses the character image and the estimated writing direction as inputs, rotates the character image in a direction assumed by the character recognition unit 126, and outputs a rotated character image. For example, in the cases of horizontal writing and vertical writing, the image rotation unit 123 outputs, as the rotated character image, the character image as it is for horizontal writing, and an image obtained by rotating the character image counterclockwise by 90 degrees for vertical writing. Note that the image rotation unit 123 can be omitted in a case where it is assumed that the character recognition unit 126 receives as an input the character image that is not to be rotated.

The number-of-characters estimation unit 124 estimates the number of characters by using the character image acquired by the acquisition unit 121 or the image feature extracted by the encoder 126a as an input to a model (hereinafter, a number-of-characters estimation model) of estimating the number of characters, and outputs an estimated number of characters. For example, the number-of-characters estimation unit 124 estimates the number of characters by using the character image as an input to the number-of-characters estimation model, and outputs the estimated number of characters. In addition, for example, the number-of-characters estimation unit 124 outputs the estimated number of characters by using the image feature as an input to the number-of-characters estimation model.

The model learning unit 125 performs learning of a model (hereinafter, a character recognition model) of performing processing by the encoder 126a and the decoder 126b on the basis of a correct character string corresponding to the character image and a character string that is estimated (hereinafter, an estimated character string). In addition, the model learning unit 125 performs learning of the character recognition model and the number-of-characters estimation model on the basis of a correct number of characters corresponding to the character image and the estimated number of characters. For example, the model learning unit 125 performs learning of a character recognition model of extracting an image feature from the rotated character image and estimating a character string from the image feature and the estimated writing direction.

In addition, for example, the model learning unit 125 performs learning of a character recognition model of extracting an image feature from the character image and estimating a character string from the image feature and the estimated number of characters, and a number-of-characters estimation model of estimating the number of characters from the image feature.

In addition, for example, the model learning unit 125 performs learning of a character recognition model of extracting an image feature from the rotated character image, estimating the number of characters from the image feature and the estimated writing direction, and estimating a character string from the image feature, the estimated writing direction, and the estimated number of characters.

The character recognition unit 126 includes the encoder 126a and the decoder 126b. The encoder 126a extracts an image feature from the character image. For example, the encoder 126a extracts the image feature from the character image acquired by the acquisition unit 121. In addition, for example, the encoder 126a extracts the image feature from the rotated character image. In addition, for example, the encoder 126a extracts the image feature including an element that enables estimation of the number of characters from the character image. Here, the encoder 126a extracts a feature in consideration of a series by, for example, a convolutional neural network and a transformer encoder.

The decoder 126b outputs an estimated character string from the image feature. Note that the decoder 126b recursively generates an output. For example, the decoder 126b estimates the character string from the image feature and the estimated writing direction, and outputs the estimated character string. For example, the decoder 126b estimates the character string using the image feature and the estimated writing direction output from the writing direction estimation unit 122 as inputs, and outputs the estimated character string. In addition, for example, the decoder 126b estimates the writing direction from the image feature, outputs the estimated writing direction, then estimates the character string, and outputs the estimated character string.

At this time, the writing direction estimation unit 122 or the decoder 126b may input, for example, a writing direction token, which is a special token representing the estimated writing direction, to the decoder 126b instead of a start token <s>. For example, the information processing apparatus 100 defines horizontal writing as <h> and vertical writing as <v> as the writing direction tokens. The writing direction token is registered in a dictionary in advance similarly to other tokens. Note that the start token <s> is a token of an initial value of decoding by the decoder 126b. In addition, an end token <e> is a token indicating the end of decoding by the decoder 126b.

In addition, for example, the decoder 126b estimates a character string from the image feature and the estimated number of characters, and outputs the estimated character string. For example, the decoder 126b estimates the character string using the image feature and the estimated number of characters output from the number-of-characters estimation unit 124 as inputs, and outputs the estimated character string. In addition, for example, the decoder 126b estimates the character string from the image feature including the element that enables estimation of the number of characters, and outputs the estimated character string. In addition, for example, the decoder 126b estimates the number of characters from the image feature, outputs the estimated number of characters, then estimates the character string, and outputs the estimated character string.

Here, the estimated number of characters is converted into, for example, a number-of-characters token representing the number of characters, and then input to the decoder 126b instead of the start token <s>. At this time, the information processing apparatus 100 defines the number-of-characters token as <n>, for example, with n as the estimated number of characters. Note that the information processing apparatus 100 registers the number-of-characters token in the dictionary in advance similarly to other tokens.

In addition, for example, the decoder 126b estimates the character string from the image feature, the estimated writing direction, and the estimated number of characters, and outputs the estimated character string. For example, the decoder 126b outputs the estimated character string using the image feature, the estimated writing direction output from the writing direction estimation unit 122, and the estimated number of characters output from the decoder 126b as inputs. In addition, for example, the decoder 126b estimates and outputs the number of characters and the writing direction from the image feature, then estimates a character string, and outputs the estimated character string.

### Character String Estimation Using Estimated Writing Direction

### Overview

The information processing apparatus 100 estimates a character string by the decoder 126b using an estimated writing direction.

### First Embodiment

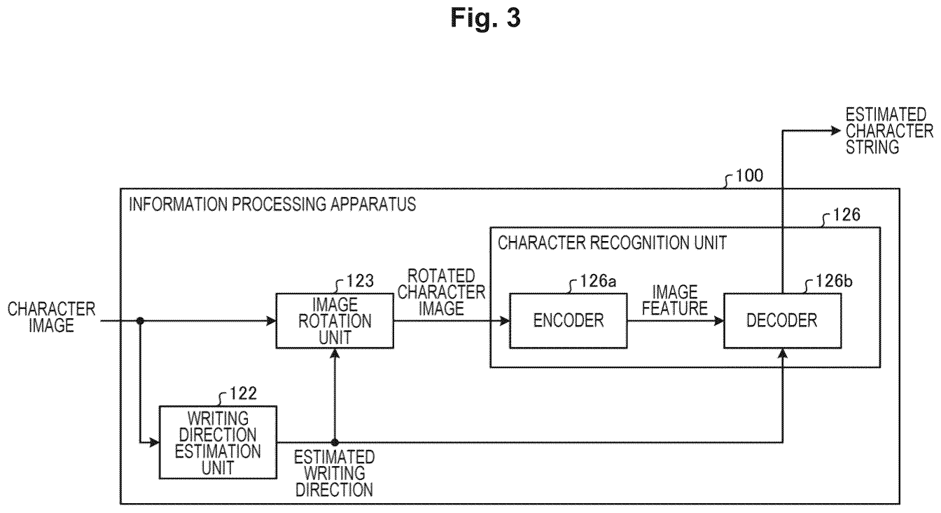

The first embodiment of the information processing apparatus 100 will be described with reference to FIGS. 3 to 6. FIG. 3 illustrates an example of a configuration of the information processing apparatus 100 in the first embodiment. The information processing apparatus 100 includes the writing direction estimation unit 122, the image rotation unit 123, and the character recognition unit 126. In addition, the character recognition unit 126 includes the encoder 126a and the decoder 126b.

The writing direction estimation unit 122 estimates a writing direction using a character image as an input and outputs the writing direction as an estimated writing direction. The image rotation unit 123 uses the character image and the estimated writing direction as inputs, rotates the character image in a direction assumed by the character recognition unit 126, and outputs the character image as a rotated character image.

The encoder 126a uses the rotated character image as an input and outputs an image feature. The decoder 126b uses the image feature and the estimated writing direction output from the writing direction estimation unit 122 as inputs, and outputs an estimated character string. Here, the estimated writing direction output by the writing direction estimation unit 122 is converted into, for example, a special token (a writing direction token) representing the estimated writing direction, and is input to the decoder instead of the start token. The writing direction token is defined as, for example, <h> for horizontal writing and <v> for vertical writing. The writing direction token is registered in the dictionary in advance similarly to other tokens.

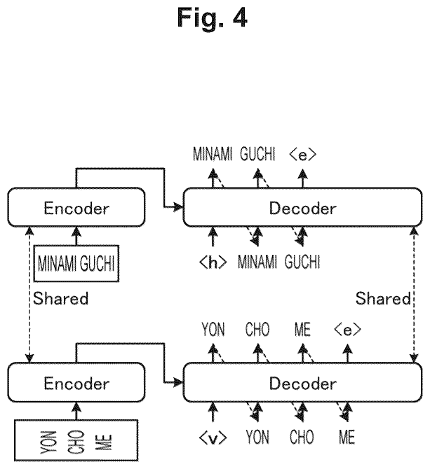

FIG. 4 is an example of operation of the character recognition unit 126 in the first embodiment. In a case where horizontal writing is estimated by the writing direction estimation unit 122, the writing direction token <h> is input to the decoder 126b instead of the start token <s>>, so that the decoder 126b recognizes that an input image is written in horizontal writing, and correctly decodes a character string.

Note that the model learning unit 125 performs learning of a model such as Formula 2 based on an estimated writing direction d in estimation of a generation probability P of a character string C={c_1, . . . , c_T} written in a character image I, whereby the character recognition unit 126 can perform character recognition.

$$\begin{matrix}[ Math . 2 ] & \\ P ( C \vert I , d ; Θ ) = {\prod }_{t = 1}^{T} P ( {c}_{t} \vert I , d , {c}_{1} , … , {c}_{t - 1} ; Θ ) & ( 2 )\end{matrix}$$

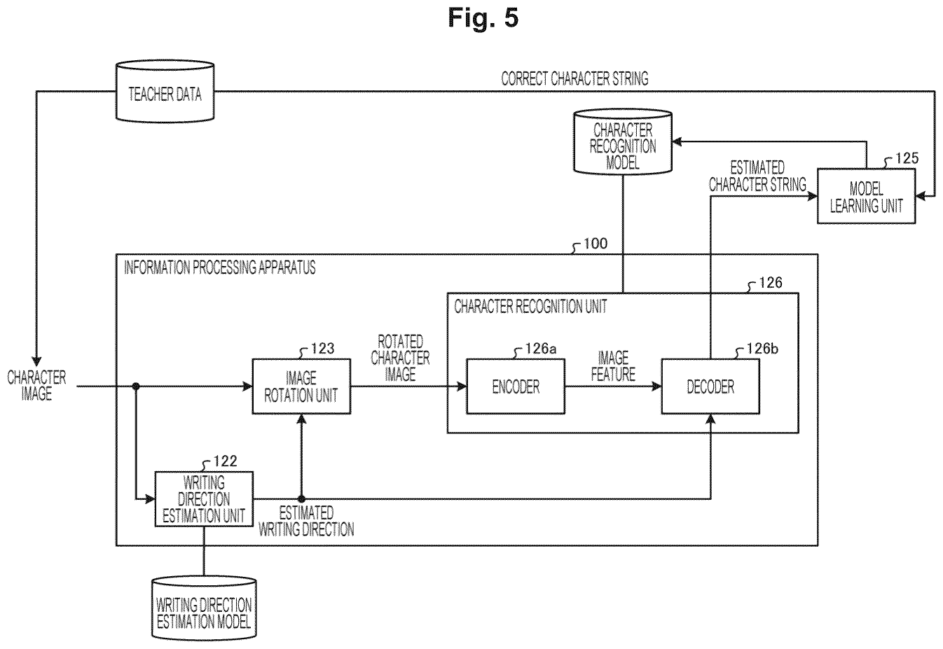

Here, Θ is a learnable model parameter. As illustrated in FIG. 5, the model learning unit 125 can optimize parameters of the character recognition model including the encoder 126a and the decoder 126b by a back propagation method, for example, using, as teacher data, a set of a character image, a corresponding correct character string, and an estimated writing direction derived by the writing direction estimation unit 122.

### Flowchart

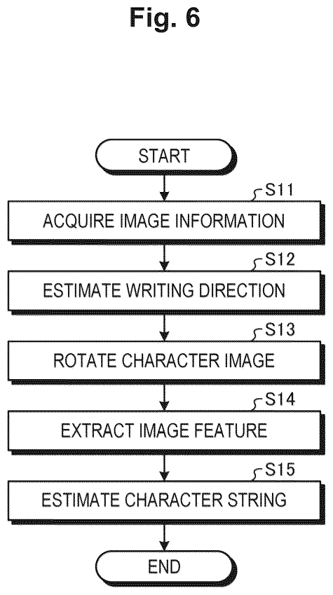

Next, a flow of information processing by the information processing apparatus 100 will be described with reference to FIG. 6. Note that steps S11 to S15 below can also be executed in a different order. In addition, some of processing steps may be omitted from steps S11 to S15 below.

First, the acquisition unit 121 acquires a character image (step S11). Next, the writing direction estimation unit 122 uses the character image acquired by the acquisition unit 121 as an input to the writing direction estimation model, and estimates a writing direction of characters included in the character image (step S12).

Then, the image rotation unit 123 rotates the character image on the basis of the estimated writing direction of the characters included in the character image estimated by the writing direction estimation unit 122 (step S13). Note that the image rotation unit 123 does not have to rotate the character image in a case where a rotated image is not assumed in the encoder 126a, the decoder 126b, or the like.

Then, the encoder 126a extracts an image feature from the character image (step S14). For example, the encoder 126a extracts the image feature from the character image acquired by the acquisition unit 121. In addition, for example, the encoder 126a extracts the image feature from character information included in a rotated character image rotated by the image rotation unit 123.

Then, the decoder 126b estimates a character string from the image feature extracted by the encoder 126a and the estimated writing direction (step S15).

### Effects

With the above-described configuration, the information processing apparatus 100 can efficiently model character recognition that can recognize both characters in horizontal writing and vertical writing. Specifically, by sharing all model parameters between horizontal writing and vertical writing, the information processing apparatus 100 can share outlines peculiar to characters useful for character recognition and vocabulary between horizontal writing and vertical writing. Then, the information processing apparatus 100 can correctly decode a character string in horizontal writing and vertical writing by providing a writing direction token for distinguishing horizontal writing and vertical writing as an initial value of an autoregressive decoder.

### Second Embodiment

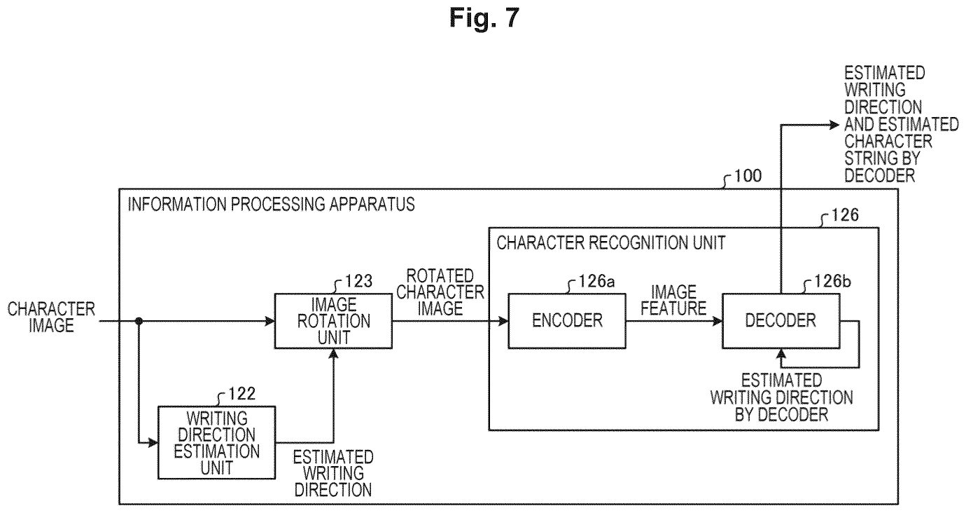

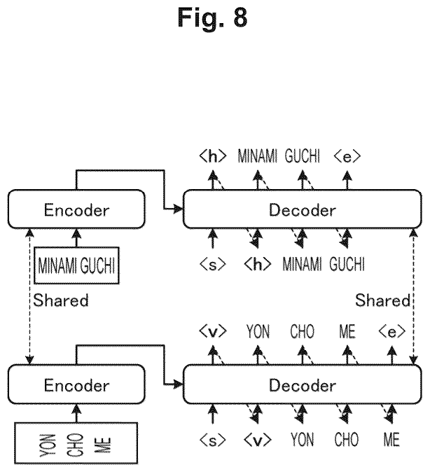

The second embodiment of the information processing apparatus 100 will be described with reference to FIGS. 7 to 8. The second embodiment is different from the first embodiment in that the writing direction is estimated by the decoder 126b without inputting the estimated writing direction to the decoder 126b. That is, the decoder 126b estimates the writing direction from the image feature, outputs the estimated writing direction, and then estimates the character string.

FIG. 7 illustrates an example of the configuration of the information processing apparatus 100 in the second embodiment. The decoder 126b in the second embodiment uses the image feature as an input, and first outputs the estimated writing direction by the decoder 126b as a writing direction token. Then, the image feature and the estimated writing direction by the decoder 126b represented by the writing direction token are used as inputs, and the estimated character string is output.

FIG. 8 is an example of operation of the character recognition unit 126 in the second embodiment. In a case where horizontal writing is estimated by the writing direction estimation unit 122, when the start token <s> is input, the decoder 126b first estimates the writing direction and outputs the writing direction token <h> as the estimated writing direction. Subsequently, the writing direction token <h> is input to the decoder 126b, so that the decoder 126b correctly decodes the character string on the basis of the fact that the input image is written in horizontal writing.

Processing in the second embodiment is common to that in FIG. 6, but is different in that the decoder 126b does not receive the estimated writing direction as an input, and a character string including a writing direction token is obtained as an output.

### Character String Estimation Using Estimated Number of Characters

### Overview

The information processing apparatus 100 estimates a character string by the decoder 126b using an estimated number of characters.

### Third Embodiment

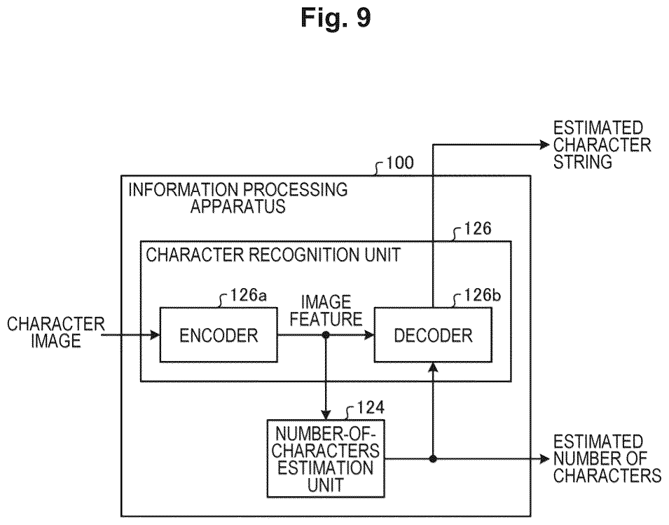

The third embodiment of the information processing apparatus 100 will be described with reference to FIGS. 9 to 12. FIG. 9 is an example of the configuration of the information processing apparatus 100 in the third embodiment. The information processing apparatus 100 includes the number-of-characters estimation unit 124 and the character recognition unit 126. In addition, the character recognition unit 126 includes the encoder 126a and the decoder 126b.

The encoder 126a uses a character image as an input and outputs an image feature. The decoder 126b uses the image feature and an estimated number of characters output from the number-of-characters estimation unit 124 as inputs, and outputs an estimated character string.

Here, the estimated number of characters output by the number-of-characters estimation unit 124 is converted into, for example, a special token (number-of-characters token) representing the number of characters, and then is input to the decoder instead of the start token. The number-of-characters token is defined as <n>, for example, with n as the estimated number of characters. The number-of-characters token is registered in the dictionary in advance similarly to other tokens.

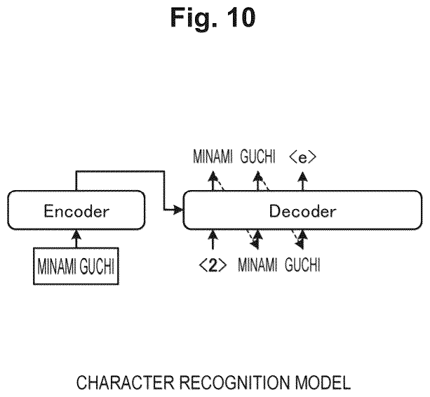

FIG. 10 is an example of operation of the character recognition unit 126 in the third embodiment. In the character recognition model of FIG. 10, in a case where the estimated number of characters is estimated to be “2” by the number-of-characters estimation unit 124, a number-of-characters token <2> is input to the decoder 126b instead of the start token <s>>, and the decoder 126b subsequently outputs an estimated character string.

Note that the model learning unit 125 performs learning of a model such as Formula 3 using an estimated number of characters n in the estimation of the generation probability P of the character string C={c_1, . . . , c_T} written in the character image I, whereby the information processing apparatus 100 can perform character recognition.

$$\begin{matrix}[ Math . 3 ] & \\ P ( C \vert I ; Θ ) = P ( n \vert I ; Θ ) P ( C \vert I , n ; Θ ) = P ( n \vert I ; Θ ) {\prod }_{t = 1}^{T} P ( {c}_{t} \vert I , n , {c}_{1} , … , {c}_{t - 1} ; Θ ) & ( 3 )\end{matrix}$$

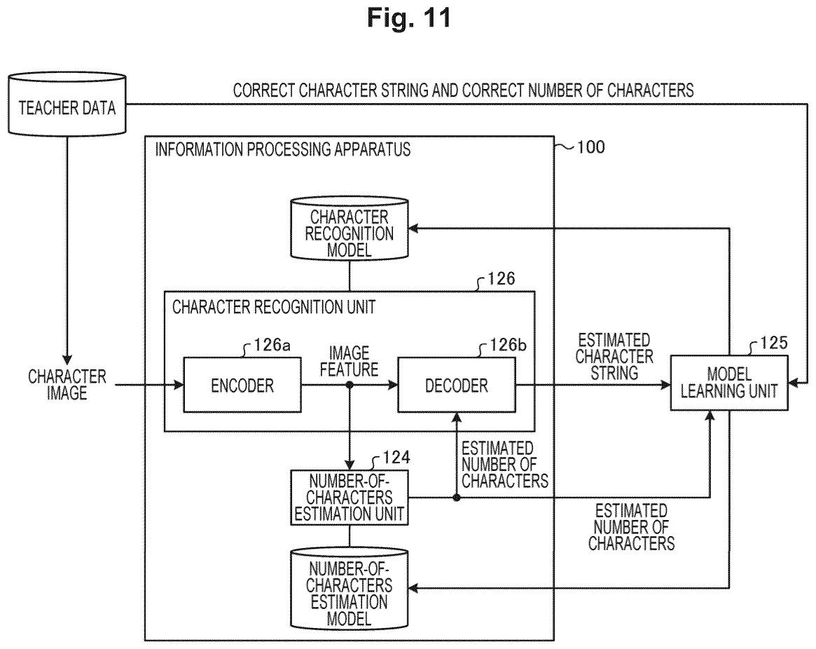

Here, Θ is a learnable model parameter. As illustrated in FIG. 11, the model learning unit 125 can optimize parameters of the character recognition model including the encoder 126a and the decoder 126b and parameters of the number-of-characters estimation model by a back propagation method, for example, using, as teacher data, a set of a character image, a corresponding correct character string, and the correct number of characters that can be derived from the correct character string.

### Flowchart

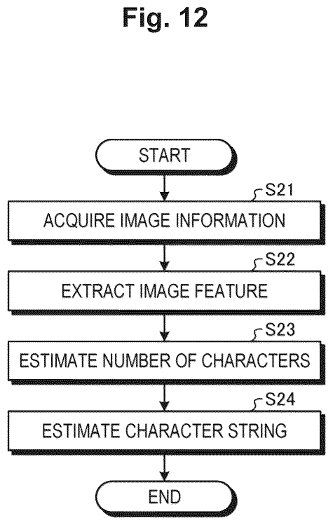

Next, a flow of information processing in the third embodiment will be described with reference to FIG. 12. Note that steps S21 to S24 below can also be executed in a different order. In addition, some of processing steps may be omitted from steps S21 to S24 below.

First, the acquisition unit 121 acquires a character image (step S21). Next, the encoder 126a extracts an image feature (step S22). Then, the number-of-characters estimation unit 124 uses the image feature as an input to the number-of-characters estimation model, and estimates the number of characters (step S23). Note that the processing in step S23 may be performed by the decoder 126b estimating the number of characters from the image feature.

Then, the decoder 126b estimates a character string from the image feature extracted from the character image and an estimated number of characters estimated by the number-of-characters estimation unit 124 (step S24).

### Fourth Embodiment

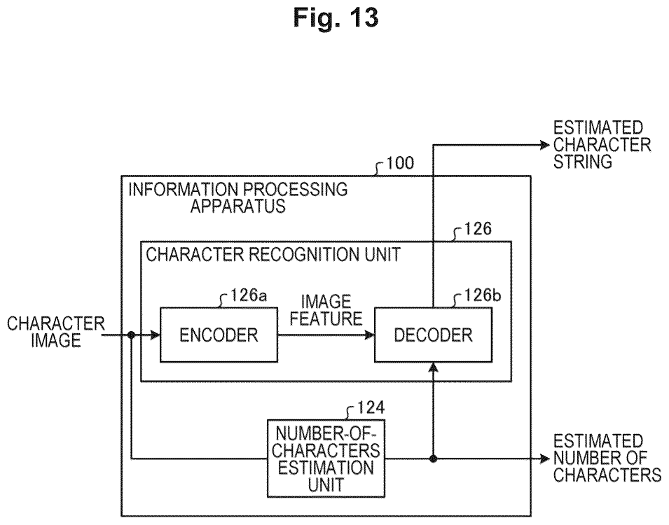

The fourth embodiment of the information processing apparatus 100 will be described with reference to FIG. 13. FIG. 13 is an example of the configuration of the information processing apparatus 100 in the fourth embodiment. The fourth embodiment is different from the third embodiment in that the input to the number-of-characters estimation unit 124 is not an image feature but a character image. The number-of-characters estimation unit 124 in the fourth embodiment uses a character image as an input, estimates the number of characters written in the character image by a number-of-characters prediction model, and outputs an estimated number of characters. Similarly to the third embodiment, for example, a machine learning model of estimating the number of characters by regression can be used as the number-of-characters prediction model.

With the above configuration, for example, it is possible to perform two-stage learning such that learning of the number-of-characters prediction model is performed in advance as a model of predicting an estimated number of characters from a character image, and learning of the encoder and the decoder is performed by fixing parameters of the number-of-characters prediction model. Note that a flow of processing is similar to that in FIG. 12.

### Fifth Embodiment

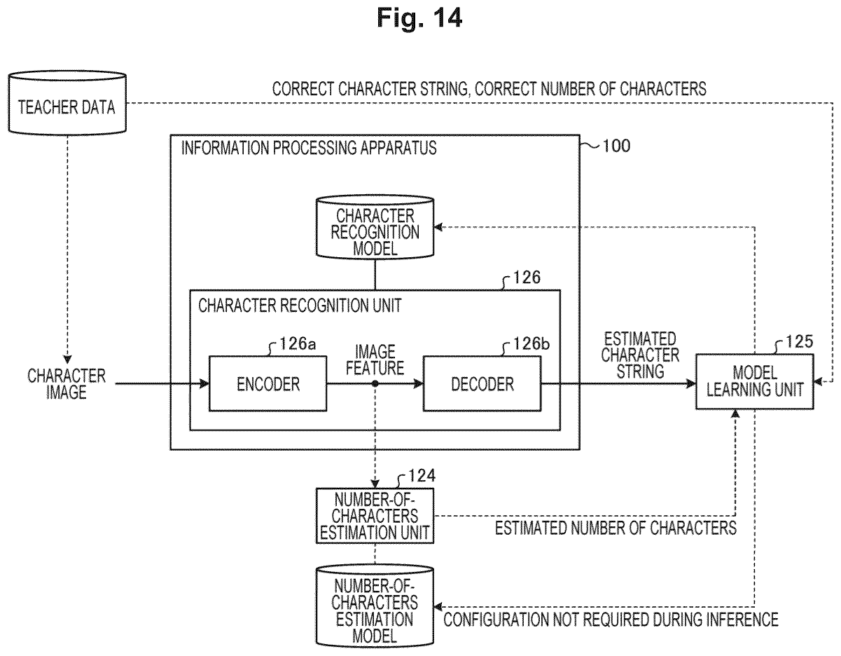

The fifth embodiment of the information processing apparatus 100 will be described with reference to FIG. 14. FIG. 14 is an example of the configuration of the information processing apparatus 100 in the fifth embodiment. The fifth embodiment is different from the third embodiment in that the estimated number of characters is not input to the decoder 126b.

With the above configuration, the number-of-characters estimation unit 124 is combined at the time of learning, and learning of the parameters of the model is performed and optimized so that the estimated number of characters and the character string can be correctly estimated, whereby the encoder 126a outputs an image feature having an element that enables estimation of the number of characters. As a result, the encoder 126a can output an image feature in consideration of character separation, and prediction accuracy of a character string is improved.

### Sixth Embodiment

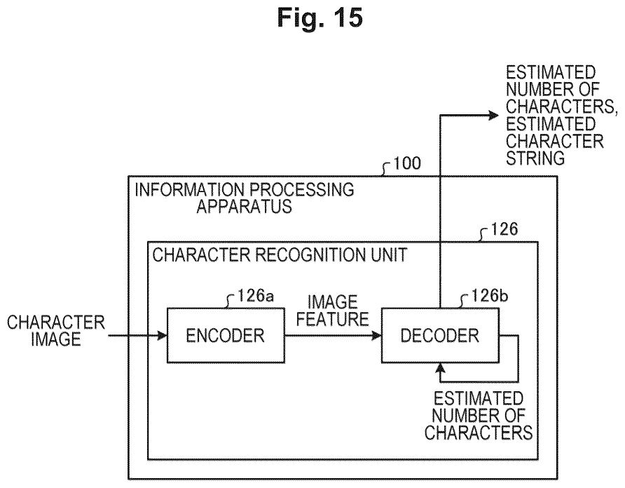

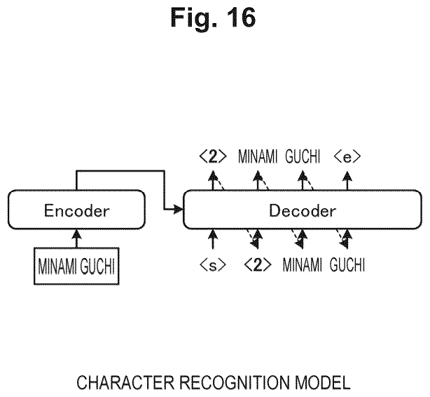

The sixth embodiment of the information processing apparatus 100 will be described with reference to FIGS. 15 and 16. FIG. 15 is an example of the configuration of the information processing apparatus 100 in the sixth embodiment. The sixth embodiment is different from the third embodiment in that the number-of-characters estimation unit 124 is not included and the number of characters is estimated by the decoder 126b.

The decoder 126b in the sixth embodiment uses an image feature as an input, and first outputs an estimated number of characters as a number-of-characters token. Then, the estimated number of characters represented by the image feature and the number-of-characters token is used as an input, and an estimated character string is output.

FIG. 16 is an example of operation of the character recognition unit 126 in the sixth embodiment. In the character recognition model of FIG. 16, the decoder 126b estimates the number of characters, thereby estimating that the number of characters is “2”. Then, the number-of-characters token <2> is input to the decoder 126b subsequent to the start token <s>, and the decoder 126b performs output using the estimated number of characters.

### Effects

With the above configuration, the information processing apparatus 100 can predict the number of characters prior to character recognition, and predict a character string on the basis of the predicted number of characters. As a result, the information processing apparatus 100 performs prediction of the number of characters, in which it is required to recognize a group of characters by capturing an image in a bird's eye view, before predicting a character string, and thus implements character recognition in consideration of the group of characters. For this reason, the information processing apparatus 100 particularly improves accuracy of character recognition in a language such as Japanese in which there are characters that become different characters when divided like a left-hand portion and a right-hand portion.

### Character String Estimation Using Estimated Writing Direction and Estimated Number of Characters

### Overview

The information processing apparatus 100 estimates a character string by the decoder 126b using an estimated writing direction and an estimated number of characters.

### Seventh Embodiment

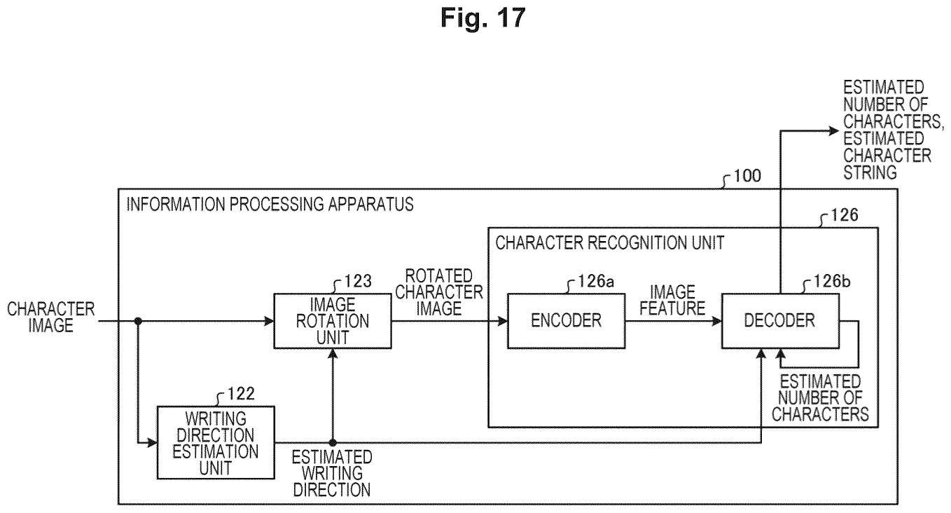

The seventh embodiment of the information processing apparatus 100 will be described with reference to FIGS. 17 to 20. FIG. 17 is an example of the configuration of the information processing apparatus 100 in the seventh embodiment. The seventh embodiment is a combination of the first embodiment and the sixth embodiment. The seventh embodiment is different from the first embodiment in the processing by the decoder 126b. The decoder 126b in the seventh embodiment first outputs the estimated number of characters as the number-of-characters token, using the image feature and the estimated writing direction represented by the writing direction token as inputs. Then, the image feature and the estimated writing direction represented by the writing direction token, and the estimated number of characters represented by the number-of-characters token are used as inputs, and the estimated character string is output.

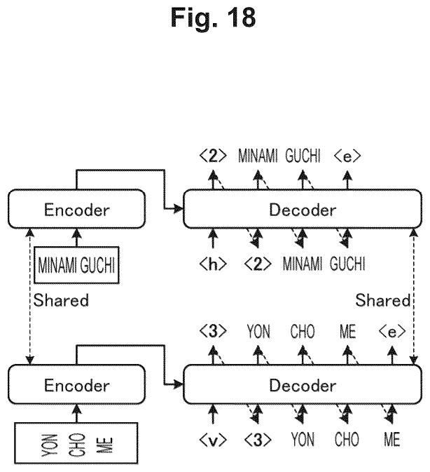

FIG. 18 is an example of operation of the character recognition unit 126 in the seventh embodiment. In the character string estimation model, in a case where the writing direction estimation unit 122 estimates that the writing direction is horizontal writing, the writing direction token <h> is input to the decoder instead of the start token <s>.

Thereafter, in a case where the decoder 126b estimates that the estimated number of characters is “2”, the number-of-characters token <2> is input to the decoder subsequent to the writing direction token <h>, and the decoder 126b performs output using the estimated writing direction and the estimated number of characters.

Note that the model learning unit 125 performs learning of a model such as Formula 4 using the estimated number of characters n on the basis of the estimated writing direction d in estimation of the generation probability P of the character string C={c_1, . . . , c_T} written in the character image I, whereby the character recognition unit 126 can perform character recognition.

$$\begin{matrix}[ Math . 4 ] & \\ P ( C \vert I , d ; Θ ) = P ( n \vert I , d ; Θ ) P ( C \vert I , d , n ; Θ ) = P ( n \vert I , d ; Θ ) {\prod }_{t = 1}^{T} P ( {c}_{t} \vert I , d , n , {c}_{1} , … , {c}_{t - 1} ; Θ ) & ( 4 )\end{matrix}$$

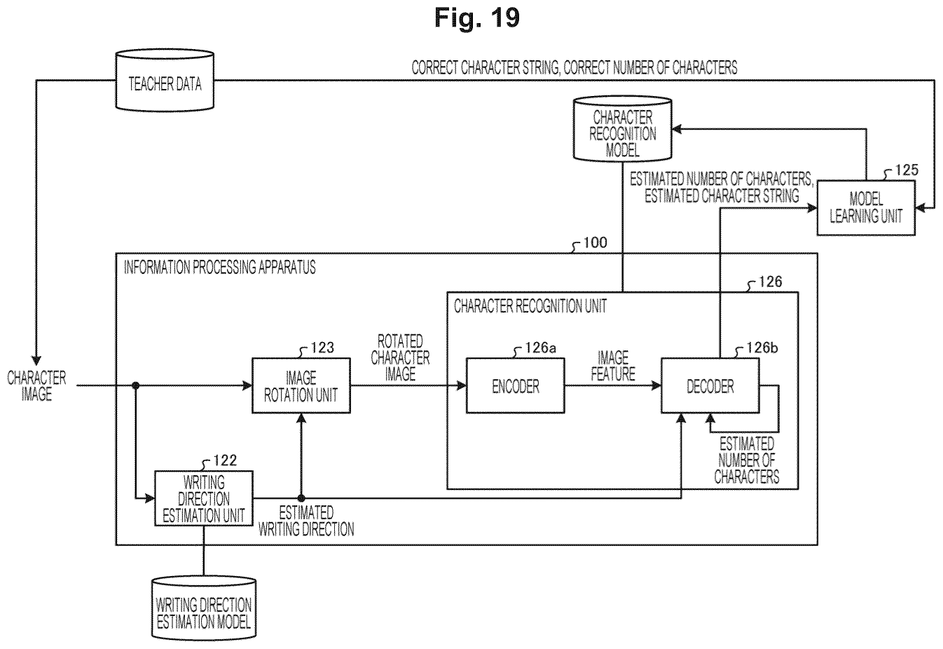

Here, Θ is a learnable model parameter. As illustrated in FIG. 19, the model learning unit 125 can optimize parameters of the model learning unit including the encoder 126a and the decoder 126b by a back propagation method, for example, using, as teacher data, a set of a character image, a corresponding correct character string, an estimated writing direction derived by the writing direction estimation unit 122 from the character image, and a correct number of characters that can be derived from the correct character string.

### Flowchart

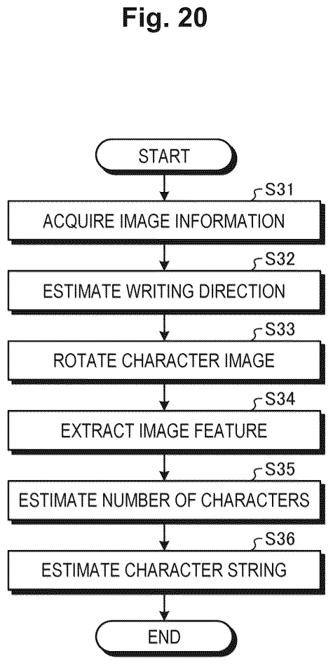

Next, a flow of information processing in the seventh embodiment will be described with reference to FIG. 20. Note that steps S31 to S36 below can also be executed in a different order. In addition, some of processing steps may be omitted from steps S31 to S36 below.

First, the acquisition unit 121 acquires a character image (step S31). Next, the writing direction estimation unit 122 uses the character image acquired by the acquisition unit 121 as an input to the writing direction estimation model, and estimates a writing direction of characters included in the character image (step S32).

Then, the image rotation unit 123 rotates the character image on the basis of the estimated writing direction of the characters included in the character image estimated by the writing direction estimation unit 122 (step S33). Note that the image rotation unit 123 does not have to rotate the character image in a case where a rotated image is not assumed in the encoder 126a, the decoder 126b, or the like.

Subsequently, the encoder 126a extracts an image feature from the character image or the rotated character image (step S34). Then, the decoder 126b estimates the number of characters from the image feature extracted from the character image (step S35). The decoder 126b estimates a character string from the image feature, the estimated writing direction, and the estimated number of characters (step S36).

### Eighth Embodiment

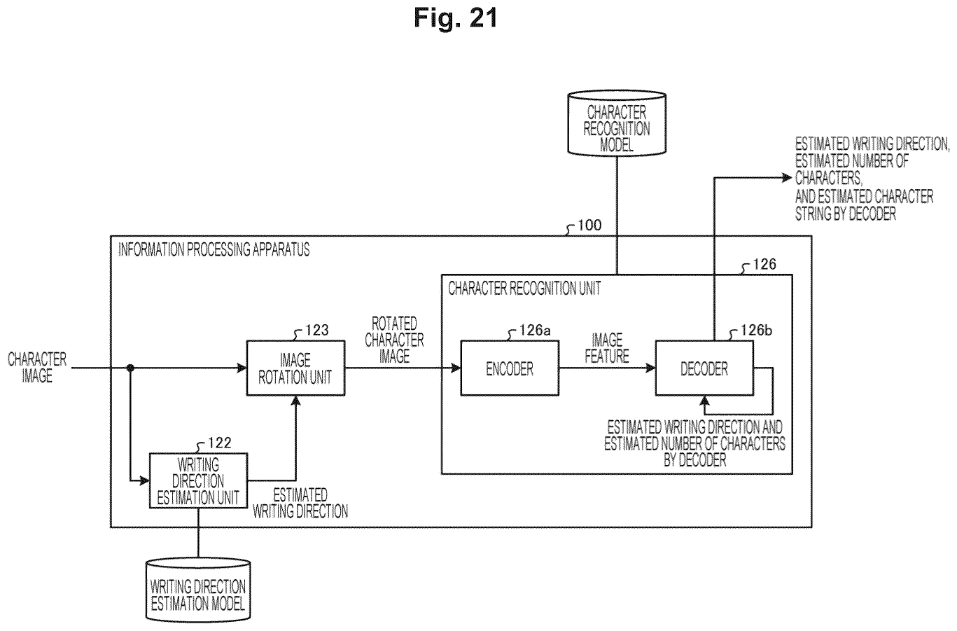

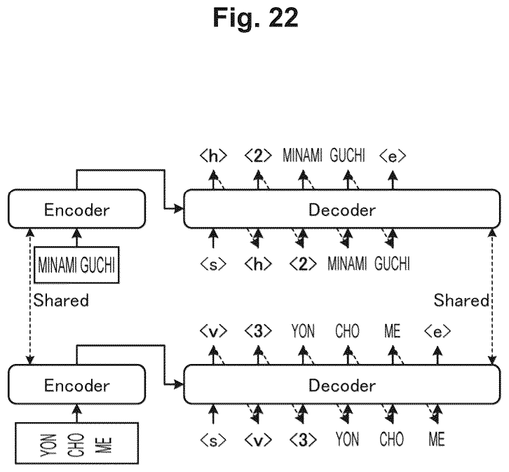

The eighth embodiment of the information processing apparatus 100 will be described with reference to FIGS. 21 and 22. FIG. 21 is an example of the configuration of the information processing apparatus 100 in the eighth embodiment. The eighth embodiment is a combination of the second embodiment and the sixth embodiment. The eighth embodiment is different from the seventh embodiment in that the estimated writing direction is not input to the decoder 126b, and the decoder 126b estimates the writing direction. That is, the decoder 126b estimates and outputs the number of characters and the writing direction from the image feature, and then estimates the character string.

FIG. 22 is an example of operation of the character recognition unit 126 in the eighth embodiment. In the character string estimation model, in a case where the decoder 126b estimates that the writing direction is horizontal writing, the writing direction token <h> is input to the decoder subsequent to the start token <s>.

Thereafter, in a case where the decoder 126b estimates that the estimated number of characters is “2”, the number-of-characters token <2> is input to the decoder subsequent to the writing direction token <h>, and the decoder functioning as the decoder 126b performs output using the estimated writing direction and the estimated number of characters. Note that the order of outputting the writing direction token and the number-of-characters token may be reversed.

### Experimental Results

A verification experiment was performed on a scene character recognition model having a structure described in Non Patent Literature 1. A target language was Japanese, and about 7,800 pieces of pair data in horizontal writing and about 700 pieces of pair data in vertical writing were used as teacher data.

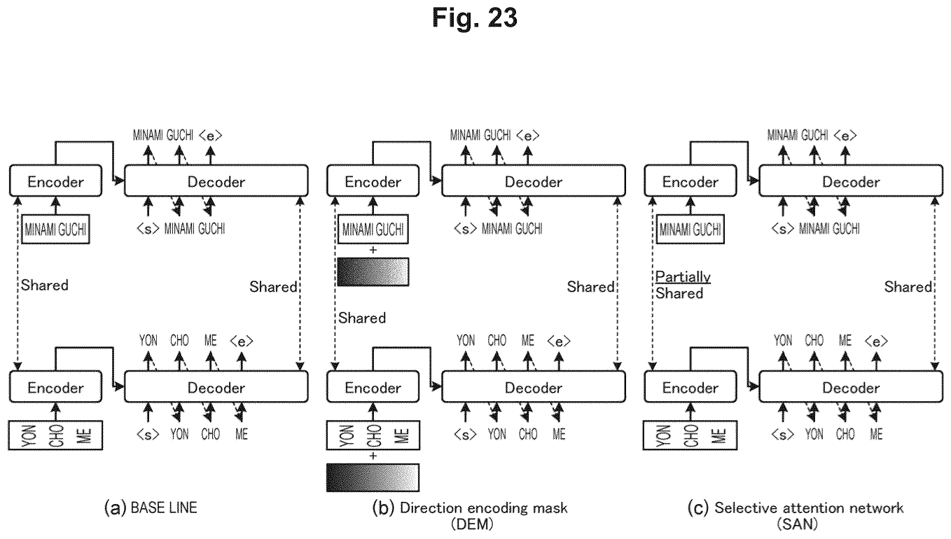

Character recognition accuracy was evaluated for the baseline of Non Patent Literature 3 as illustrated in FIG. 23(a), the DEM of Non Patent Literature 3 as illustrated in FIG. 23(b), the SAN of Non Patent Literature 3 as illustrated in FIG. 23(c), the modeling according to the first embodiment, and the modeling according to the seventh embodiment. For the evaluation, images not included in the teacher data, about 900 pieces in horizontal writing, and about 100 pieces in vertical writing were used, and an accuracy rate based on perfect match was used as a scale.

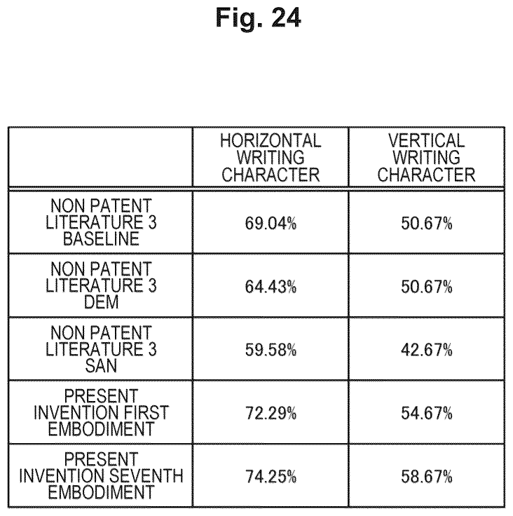

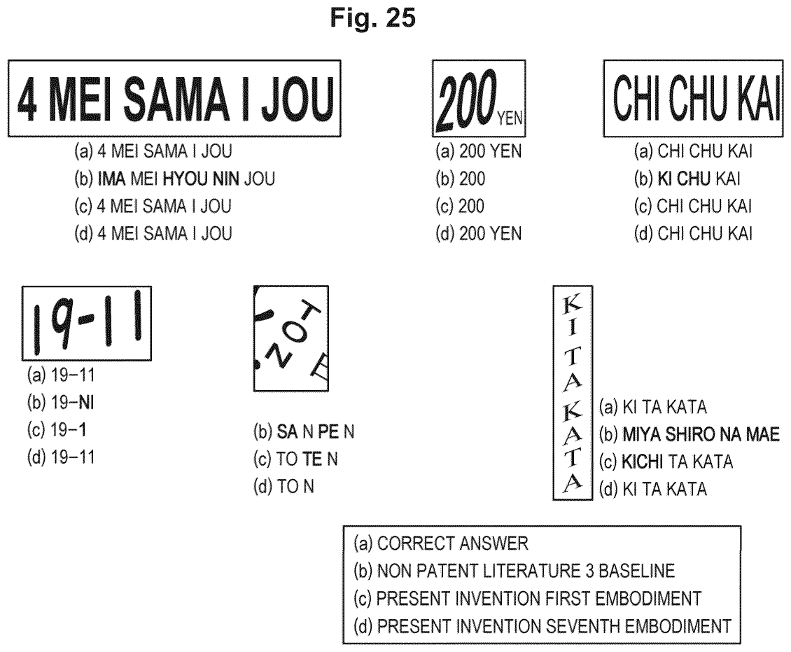

Results of the verification experiment are shown in FIG. 24. According to FIG. 24, improvement of recognition accuracy according to the present invention is confirmed in both cases of horizontal writing and vertical writing. FIG. 25 illustrates an example of recognition results. As illustrated in FIG. 25(c), it can be seen that erroneous recognition is prevented by providing the writing direction token as in the first embodiment. Further, as illustrated in FIG. 25(d), it can be seen that erroneous recognition and recognition omission are prevented by providing the number-of-characters token as in the seventh embodiment.

### System Configuration and Others

In addition, each of components of each of devices illustrated in the drawings is functionally conceptual, and is not required to be physically designed as illustrated. In other words, a specific form of distribution and integration of each device is not limited to the illustrated form, and all or part thereof can be functionally or physically distributed and integrated in any unit according to various loads, usage conditions, and the like. For example, further, all or any part of processing functions performed in each device can be implemented by a CPU and a program analyzed and executed by the CPU or can be implemented as hardware by wired logic.

In addition, among pieces of processing described in the present embodiment, all or some pieces of processing described as being performed automatically can be performed manually, or all or some pieces of processing described as being performed manually can be performed automatically in accordance with a known method. The processing procedures, control procedures, specific names, and information including various types of data and parameters described above in the specification and drawings can be optionally changed unless otherwise mentioned. In addition, the information processing apparatus 100 described in the present embodiment may be a learning apparatus including only a portion related to learning, or may be an estimation apparatus including only a portion related to estimation.

### Program

It is also possible to create a program in which the processing to be executed by the information processing apparatus 100 described in the above-described embodiments is described in a language executable by a computer. In this case, the computer executes the program, and thus effects similar to those of the above-described embodiment can be obtained. Further, such a program may be recorded in a computer-readable recording medium, and the program recorded in the recording medium may be read and executed by a computer to implement processing similar to the above-described embodiment.

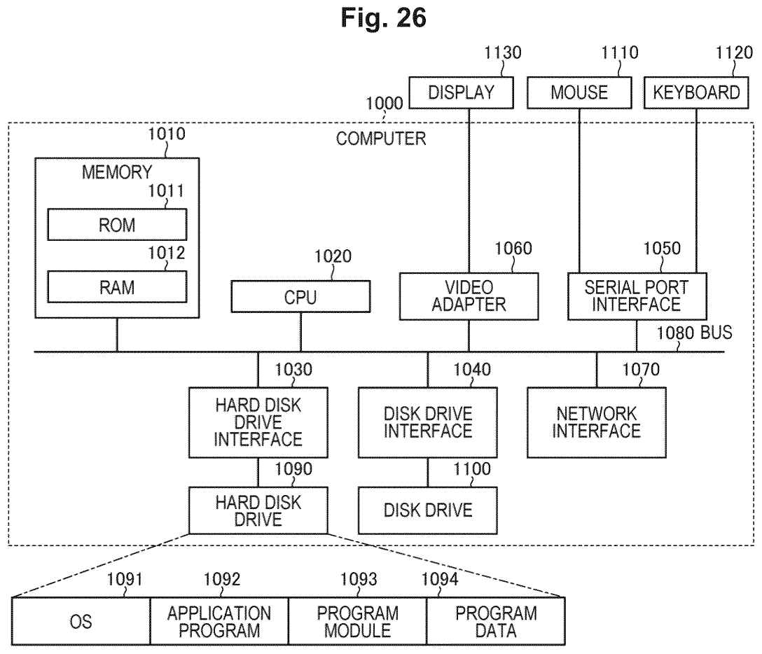

FIG. 26 is a diagram illustrating an example of the computer that executes the information processing program. As illustrated in FIG. 26, a computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read-only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. For example, the serial port interface 1050 is connected to a mouse 1110 and a keyboard 1120. The video adapter 1060 is connected to, for example, a display 1130.

Here, as illustrated in FIG. 26, the hard disk drive 1090 stores, for example, an OS 1091, an application program 1092, a program module 1093, and program data 1094. Each table described in the above embodiment is stored in, for example, the hard disk drive 1090 or the memory 1010.

In addition, the information processing program is stored in the hard disk drive 1090 as, for example, a program module including description of commands executed by the computer 1000. Specifically, the program module 1093 in which each piece of processing executed by the computer 1000 described in the above-described embodiment is described is stored in the hard disk drive 1090.

In addition, data used for information processing by the information processing program is stored in, for example, the hard disk drive 1090 as program data. Then, the CPU 1020 reads the program module 1093 and the program data 1094 stored in the hard disk drive 1090 to the RAM 1012 as necessary and executes each procedure described above.

Note that the program module 1093 and the program data 1094 related to the information processing program are not limited to being stored in the hard disk drive 1090, and may be stored in, for example, a removable storage medium and read by the CPU 1020 via the disk drive 1100 or the like. Alternatively, the program module 1093 and the program data 1094 related to the control program may be stored in another computer connected via a network such as a local area network (LAN) or a wide area network (WAN) and may be read by the CPU 1020 via the network interface 1070.

### Others

Although various embodiments have been described in detail in the present specification with reference to the drawings, the plurality of embodiments are merely examples and are not intended to limit the present invention to the plurality of embodiments. The features described herein may be implemented by various methods, including various modifications and improvements based on the knowledge of those skilled in the art.

In addition, each “module”, each suffix “-er”, and each suffix “-or” in the above description may be read as a unit, means, a circuit, or the like. For example, a communication module, a control module, and a storage module may be replaced with a communication unit, a control unit, and a storage unit, respectively.

Regarding the above embodiments, the following supplementary notes are further disclosed.

### (Supplement 1)

An information processing apparatus including:
(Supplement a memory; and
at least one processor connected to the memory,
in which
the processor
extracts an image feature from a character image, and
estimates a character string from a writing direction and the image feature.

### (Supplement 2)

The information processing apparatus according to supplement 1,
in which
the processor
estimates and outputs the writing direction from the image feature, and then estimates the character string.

### (Supplement 3)

The information processing apparatus according to supplement 1,
in which
the processor
estimates and outputs a number of characters from the writing direction and the image feature, and then estimates the character string.

### (Supplement 4)

The information processing apparatus according to supplement 1,
in which
the processor
estimates and outputs a number of characters and the writing direction from the image feature, and then estimates the character string.

### (Supplement 5)

An information processing apparatus including:
a memory; and
at least one processor connected to the memory,
in which
the processor
extracts an image feature from a character image,
estimates a character string from a writing direction and the image feature, and
on a basis of a correct character string corresponding to the character image, and the character string, performs learning of a model of performing processing of extracting the image feature from the character image and processing of estimating a character string from the writing direction and the image feature.

### (Supplement 6)

A non-transitory storage medium storing a program executable by a computer to execute information processing,
in which
the information processing is
for causing the computer to function as the information processing apparatus according to any one of the supplements 1 to 5.

### (Supplement 7)

An information processing apparatus including:
a memory; and
at least one processor connected to the memory,
in which
the processor
extracts an image feature from a character image, and
estimates a character string from the image feature and a number of characters.

### (Supplement 8)

An information processing apparatus including:
a memory; and
at least one processor connected to the memory,
in which
the processor
extracts an image feature including an element that enables estimation of a number of characters from a character image, and
estimates a character string from the image feature including the element that enables estimation of the number of characters.

### (Supplement 9)

The information processing apparatus according to supplement 1,
in which
the processor
estimates a number of characters from the image feature, outputs the number of characters, and then estimates the character string.

### (Supplement 10)

An information processing apparatus including:
a memory; and
at least one processor connected to the memory,
in which
the processor
extracts an image feature from a character image,
estimates a character string from the image feature and a number of characters, and
on a basis of a correct character string corresponding to the character image, and the character string, performs learning of a model of performing processing of extracting the image feature from the character image and processing of estimating a character string from the image feature and the number of characters.

### (Supplement 11)

The information processing apparatus according to supplement 10,
in which
the processor
estimates the number of characters from the image feature, and
on a basis of a correct number of characters corresponding to a character image, and the number of characters, estimates a character string from processing of extracting the image feature from the character image and the image feature and the number of characters.

### (Supplement 12)

A non-transitory storage medium storing a program executable by a computer to execute information processing,
in which
the information processing is
for causing the computer to function as the information processing apparatus according to any one of the supplements 7 to 11.

### REFERENCE SIGNS LIST

100 Information processing apparatus
110 Communication unit
120 Control unit
121 Acquisition unit
122 Writing direction estimation unit
123 Image rotation unit
124 Number-of-characters estimation unit
125 Model learning unit
126 Character recognition unit
126a Feature extraction unit
106b Character string estimation unit
130 Storage unit

1. An information processing apparatus comprising:
processing circuitry configured to:
extracts extract an image feature from a character image; and
estimates estimate a character string from a writing direction and the image feature.

2. The information processing apparatus according to claim 1, wherein the processing circuitry is further configured to estimate and output the writing direction from the image feature, and then estimate the character string.

3. The information processing apparatus according to claim 1, wherein the processing circuitry is further configured to estimate and output a number of characters from the writing direction and the image feature, and then estimate the character string.

4. The information processing apparatus according to claim 1, wherein the processing circuitry is further configured to estimate and output a number of characters and the writing direction from the image feature, and then estimate the character string.

5. (canceled)

6. An information processing method executed by a computer, comprising:
extracting an image feature from a character image; and
estimating a character string from a writing direction and the image feature.

7. (canceled)

8. A non-transitory computer-readable recording medium storing therein an information processing program that causes a computer to execute a process comprising:
extracting an image feature from a character image; and
estimating a character string from a writing direction and the image feature.
